(19) United States
(12) Patent Application Publication
(10) Pub. No.: US 2001/0054646 A1
(43) Pub. Date: Dec. 27, 2001

(54) Apparatus and method for reading bar code printed card, and bar code recording media card

(75) Inventors: Yasufumi Hosokawa, Yamanashi (JP); Masayuki Takatsuka, Yamanashi (JP); Motoki Kasai, Yamanashi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Nisca Corporation, Minamikoma-gun (JP)

(21) Appl. No.: 09/862,308

(22) Filed: May 23, 2001

(30) Foreign Application Priority Data
May 24, 2000 (JP) 2000-152856
Jan. 23, 2001 (JP) 2001-014392

(51) Int. Cl. G06K 7/10

(52) U.S. Cl. 235/462.25

(57) ABSTRACT

A bar-code reading system, a bar-code reader, a recording medium for the bar-code reader, and a method of reading a bar code, and of the present invention are disclosed. The bar-code reading system of the present invention is able to read the information represented by a bar code on a card with reliability and with high accuracy by passing the card through the card reader one time in spite of the presence of defect in any pixel of the bar code printed on the card. The bar-code reading system has a reading device for reading a medium on which a bar code is printed, by an image sensor having photo-electric conversion elements arranged in line, and a processing device for performing a predetermined process on the basis of information read by the reading device. The bar-code reading system is configured to read the bar code under the conditions in which the reading line of the image sensor and the direction of relative displacement of the card cross each other at a predetermined angle. The image sensor reads the bar code several times during the relative parallel displacements of the image sensor and the card. The bar-cord reader has a card insertion slot for receiving the card, a card ejection slot for removing the card read by the image sensor, and a transporting device for transporting the card to either the insertion slot or the ejection slot.

### BACKGROUND OF THE INVENTION

1. Field of the Invention

The present invention relates to a bar-code reader for optically reading a bar code printed on the surface of a reading medium. Especially, the present invention relates to a bar-code reading system and a bar-code recording medium for reading a bar code printed on a card such as a card issued by a amusement arcade, a hospital card for specifying a patient and managing a medical history thereof, or a library card for a library user.

2. Description of the Related Art

A bar code is provided as a printed pattern of lines or bars, for example a predetermined combination of dark (black) and light (white) bars of varying widths. The bar code is used in many fields because it can be read and recognized with facility, compared with the recognition system of numerical character or the like. Such a bar cord may be used as a previously printed pattern of lines or bars on a consumer product package to identify the product at the time of purchase or on a card to identify the card itself or a person who holds the card.

On the other hand, a bar code reader for reading the bar code is designed as a wand or pen type optical point sensor to be held by an operator to scan the bar code from left to right or versa in a direction perpendicular to the lines or bars. Alternatively, it is designed as a hand-held type scanner for reading a bar code on the product or the like by putting its optical line sensor portion over the bar code. Otherwise, it is designed as a stationary type scanner to be connected to an electronic cash register equipped in a retail store or the like.

A bar-code reader to be discussed for specifying the present invention is of a stationary type. It reads a bar code previously printed on a medium such as a card to identify the card itself or a person who holds the card.

An optical sensor means that constitutes the bar-code reader may be designed as an optically condensed type one or a contact image sensor (hereinafter, abbreviated as CIS). The optically condensed type optical sensor comprises an optical source for irradiating the bar code with light, a mirror means for reflecting the light, a lens means for converting the reflected light, and an optical sensor means for converting the reflected light to electrical signals. Alternatively, the CIS is an optical line sensor in which those means are implemented therein as compact as possible. The present invention described later may be applied on any bar-code reader using any type of the optical line sensor means on the same basic principle as that of each of the above type. Hereinafter, therefore, we will describe the examples using a smaller and comparatively simple structured CIS in the present specification.

FIGS. 12(a) and 12(b) are schematic diagrams that illustrate schemes of reading a bar code by the conventional bar-code reader, respectively. In the figures, the reference numeral 51 denotes a bar code, 51a denotes one of bars in the bar code 51, 52 denotes another bar code, and 52a denotes one of bars in the bar code 52.

As shown in FIGS. 12(a) and 12(b), the conventional bar-code reader for reading a bar code printed on a card or the like reads the bar code in the direction perpendicular to the length of each bar. That is, the direction of moving the card (i.e., a sub-scanning direction) is coincident with the direction of reading the bar code (i.e., a main scanning direction). The conventional bar-code reader is configured so that a card runs over a point type optical sensor installed on the passage of card, or alternatively it is configured so that an optical line sensor is placed in parallel to the sub-scanning direction. Therefore, the bar code on the card is re-inserted into a card port of the bar-code reader when the reader fails to read the bar code.

However, the conventional bar-code reader using the CIS has several disadvantages to be solved.

If the bar-code reader reads the bar code 51, as shown in FIG. 12(a), an image recognition is performed on the bar 51a by a pixel “i” of the optical line sensor at any position on the bar 51a even though the scanning line of the bar-code reader is shifted from “A” to “B”. In this case, however, there is a possibility that the bar 51a cannot read correctly as any trouble has accidentally happed on the pixel “i” or a dust or the like is adhered on an area in the optical passage. In this case, the insertion of card into the bar-code reader is retried two or more times until the bar code is read correctly.

Furthermore, as shown in FIG. 12(b), if it is considered that the CIS moves along the allow in the figure to read the bar code 52, pixels (i, i+1, i+2, ...) read the bar 52a in order. Thus, the above problem on the light-receptive side can be solved. In this case, however, there is another problem in which the bar code cannot be read with a high precision when the bar 52 becomes inferior or fading or becomes dirty. In this case, furthermore, the bar code can be read correctly after retrying the insertion of card into the bar-code reader two or more times.

### SUMMARY OF THE INVENTION

The present invention is accomplished in view of the above problems of the conventional bar-code reader.

An object of the present invention is to provide a bar-code reading system that is able to read the information represented by a bar code on a card with reliability and with high accuracy by passing the card through the card reader one time in spite of the presence of defect in any pixel of the bar code printed on the card.

In the first aspect of the present invention, a bar-code reading system that includes a reading means for reading a medium on which a bar code is printed, by an image sensor having photo-electric conversion elements arranged in line, and a processing means for performing a predetermined process on the basis of information read by the reading means, comprises: a driving means for performing a relative movement between the photo-electric conversion elements and the medium, which crosses at a predetermined angle, wherein the processing means comprises: a reading instruction means for instructing the reading means with a reading of one line by photo-electric conversion elements concurrently with the relative movement by the driving means; a judgement means for making a judgement on the basis of reading information of at least two lines; and a control means for control the reading instruction means on the basis of an judgement information by the judgement means.

In the second aspect of the present invention, a bar-code reading system includes a reading means for reading a medium on which a bar code is printed, by an image sensor having photo-electric conversion elements arranged in line, and a driving means for moving the image sensor, wherein the image sensor is moved as the driving means and the an array of the photo-electric conversion elements cross each other at a predetermined angle.

In the third aspect of the present invention, a bar-code reading system includes a reading means for reading a medium on which a bar code is printed, by an image sensor having photo-electric conversion elements arranged in line, and a transport means to transport a medium, wherein the transport means and an array of photo-electric conversion elements cross each other at a predetermined angle.

In the fourth aspect of the present invention, a bar-code reader includes a reading means for reading a medium on which a bar code is printed, by an image sensor having photo-electric conversion elements arranged in line, and a transport means to transport a medium, wherein the direction of setting the medium at an insertion/removal slot and an array of image cross with each other.

In the fifth aspect of the present invention, a bar-code reader that includes a reading means for reading a bar-code on a medium by an image sensor having an optical source and an array of photo-electric conversion elements in line, where the array of photo-electric conversion elements is inclined at a predetermined angle and performs a relative movement with the medium to read the bar-code every one line, comprises: a reading instruction means for instructing the reading means to read one line; a judgment means for making the judgment on the basis of the reading information of at least two lines, and a control means for controlling the reading instruction means on the basis of the judgment information.

Here, the judgment means may comprise a comparison means for making a comparison between the reading information obtained by the reading means and the retry means for instructing the reading instruction means to read again when the comparison results are not agreed.

The judgment means may further comprise an error processing means for performing an error processing when the number of the re-readings reaches the predetermined number and it is considered as an error.

The judgment means may further comprise a noise examination means that examines whether the noise is in the reading information read by the reading means.

The noise examination means may sequentially examine the reading information from an image sensor by counting the number of pixels from the predetermined pixel position, and if the number of pixels is specifically changed before a predetermined number of movements is completed, it is considered as noise.

At the time of performing a relative movement with the medium every one line to read the bar code, an array of photo-converting element may be inclined at a range of 2° to 8°, in consideration of the ratio of the height and the width of various types of bar codes used in a this kind of business field.

In the sixth embodiment, a bar-code reader that includes a reading means that includes a reading means for reading a medium on which a bar code is printed, by an image sensor having photo-electric conversion elements arranged in line, and a driving means for performing a relative movement between a reading line of the reading means and the medium, comprises: an interface means that connects to an external device and performs a signal transmission/reception with an external device; a reading instruction means that instructs the reading means to perform one line reading by the photo-electric conversion elements under a relative movement by the driving means in response to a control signal from the external device through the interface means; and a transmission means for transmitting reading information read from the reading means to the external device through the interface means.

The above bar-code reader may further comprise: a comparison means for making a comparison between the reading information obtained from the respective lines by the reading means; and the retry means for instructing the reading instruction means to read again when the comparison results are not agreed.

The bar-code reader may further comprise an error processing means for performing an error processing when the number of the re-readings reaches the predetermined number and it is considered as an error.

The reading instruction means may be actuated in response to a control signal received from the interface means.

The bar-code reader may further comprise a conversion means for converting reading information into code information, where the bar-code information is sent from the interface to an external device. In the bar-code reader, at the time of performing a relative movement with the medium every one line to read the bar code, an array of photo-converting element may be inclined at a range of 2° to 8°.

In the seventh aspect of the invention, a bar-code reader that includes a reading means for reading a medium on which a bar code is printed, by an image sensor having photo-electric conversion elements arranged in line, and a driving means for performing a relative movement between a reading line of the reading means and the medium, where the reading means is arranged to read the bar code and a reading line which cross each other at a predetermined angle, may comprise: a medium-receiving slot for receiving the medium; a medium-ejecting slot for ejecting the medium; and an instruction means for instructing a transport means to transport the medium either the medium-receiving slot or the medium-ejecting slot.

A bar-code reader may further comprises: a comparison means for making a comparison between the reading information obtained by the reading means; a retry means for instructing the reading instruction means to read again when the comparison results are not agreed; and an error processing means for moving the medium to the medium-receiving slot or the medium-ejecting slot when the number of the re-readings reaches the predetermined number and it is considered as an error.

The driving means may be controlled so that the medium is moved to the medium-receiving slot or the medium-ejecting slot in response to a control signal received from the interface means.

The judgment means may further comprise a noise examination means that examines whether the noise is in the reading information read by the reading means.

The noise examination means may sequentially examine output levels of image sensor from a predetermined pixel position, and if the change of more than the predetermined level is detected during the movement through the pixels of less than predetermined number, it is considered as noise.

The bar code on the medium and the reading line may cross each other at a predetermined angle of 2° to 8°.

In the eighth aspect of the present invention, a bar-code recording medium comprises a bar code, which is printed so that the bar code and one side edge of the medium crosses each other at a predetermined angle.

The recording medium may be shaped like a general rectangular card.

The bar code may be printed so that the bar code and one side edge of the medium crosses at an angle of 2° to 8°.

In a ninth aspect of the present invention, a recording medium for a bar-code reader that transports the recording medium on which a bar code is printed and reads the bar code on the recording medium by an array of photo-electric conversion elements in line, comprises the bar code which is printed so that it consists of a group of straightlines which are parallel with each other, and the bar code and the direction of transporting the bar code crosses together at a predetermined angle.

In the tenth aspect of the invention, a method of reading a bar code having the step of reading a bar code printed on a medium by an image sensor in which photo-electric conversion elements are arranged in line, further comprises the step of reading the bar code, where the bar code is read under the condition in which the reading line and the bar code cross together at a predetermined angle.

The step of reading the bar code may further comprise a step of performing a relative movement of the reading line and the bar code.

The method further comprise the steps of: repeating the step of reading several times by moving the step of reading, performing a predetermined judgment on the basis of the reading information obtained by the step of reading being performed several times, and performing an error processing to determine the error processing on the basis of the results of the judgment step.

The above and other objects, effects, features and advantages of the present invention will become more apparent from the following description of embodiments thereof taken in conjunction with the accompanying drawings.

### BRIEF DESCRIPTION OF THE DRAWINGS

FIGS. 1(a) and l(b) are schematic diagrams that illustrate the relative displacements of a bar code and an optical sensor that reads such a bar code;

FIGS. 2(a), 2(b), and 2(c) are schematic diagrams that illustrate the first, second, and third reading positions, respectively, for showing the positional relationship between the reading line and the bar code;

FIG. 3(a) and 3(b) are schematic diagrams that illustrate bar codes to be readable in the present invention, which are not usual in the art;

FIG. 4 is a perspective diagram that illustrates a bar-code reader as one of preferred embodiments of the present invention;

FIG. 5 is a side view for illustrating the inner structure of the bar-code reader;

FIG. 6 is a top view for illustrating the inner structure of the bar-code reader;

FIG. 7 is a perspective diagram that illustrates the bar-code reader where the upper lid is being opened;

FIG. 8 is a schematic diagram that illustrates the positional relationship between the CIS and the IC card, where the CIS reads the bar code three times;

FIG. 9 is a timing chart that indicates a sequence for returning the IC card to the slot;

FIG. 10 is a schematic diagram that illustrates a timing and a relationship between the CIS and the card;

FIG. 11 is a timing chart that illustrates a positional relationship between the bar-code data printed on the card and the read line of the conventional bar-code reader;

FIG. 12(a) and FIG. 12(b) are schematic diagrams that illustrate the relative displacements of a bar code and an optical sensor that reads such a bar code for explaining the conventional method of reading the bar cord;

FIG. 13 is a block diagram that illustrates a control means of an image reader in accordance with another preferred embodiment of the present invention, in which the image reader comprises the bar-code recognition means;

FIG. 14(a) is a schematic diagram that illustrates the configuration of bar code and the direction along which the bar-code reader performs a scanning movement;

FIG. 14(B) is a graph of analog image data obtained by reading the bar code shown in FIG. 14(a), where black and white levels of each bar element and the thresholds thereof are represented;

FIG. 15 is a magnified view of the section “P7” of the bar element shown in FIG. 14(b);

FIG. 16 is a flow chart that illustrates each step of representing the reading image in binary form; and FIG. 17 is a flow chart that illustrates the process of binary data determination represented in FIG. 16.

### DETAILED DESCRIPTION OF PREFERRED EMBODIMENTS

Hereinafter, we will describe a bar-code reading system of the invention in detail with reference to the attached figures.

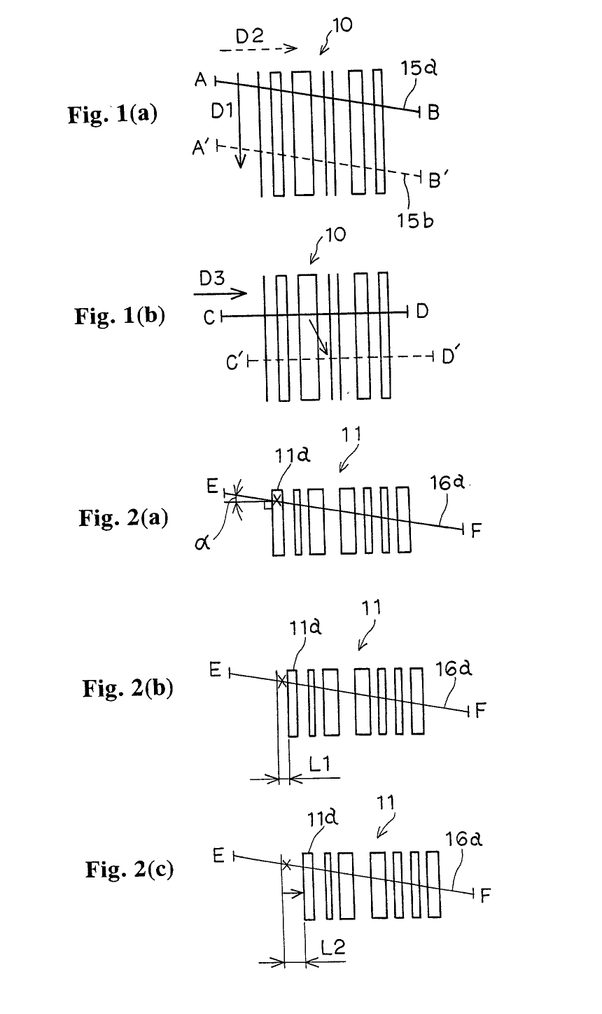

Each of FIGS. 1(a) and 1(b) illustrates the relationship between the CIS and the position of reading the bar code using a bar-code reader device in accordance with one of preferred embodiments of the present invention. Among the components of target code to be read by an image sensor, the present invention can be widely applicable if it is of an image code in which the number of pixels of the most thin component in the direction of scanning.

FIG. 1(a) illustrates the relative displacements of a code line of the bar code and a reading line of the image sensor (CIS) in a state that they cross each other at a predetermined angle. In this case, the code line is one perpendicular to the length of each bar in the bar code, corresponding to the sub-scanning direction. On the other hand, the reading line is a line of linearly-arranged photoelectric conversion elements of the CIS, corresponding the main-scanning direction.

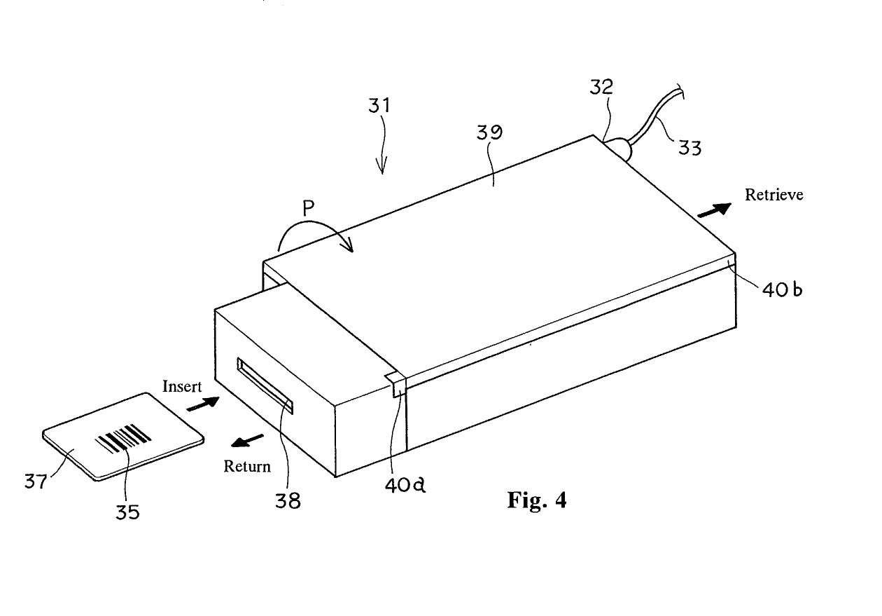

In FIG. 1(b), there is shown a scheme of performing the sub-scan so as to shift bars of the bar code along the main-scanning direction of the CIS. In FIG. 1(a), on the other hand, the CIS covers the whole of bar code 10 and shifts its position from the line 15a (extending from A to B) to the line 15b (extending from A′ to B′) in the direction indicated by the arrow “D1”. Alternatively, the CIS is fixed at the position indicated by the line 15a (extending from A to B) while the bar code 10 is moved in the direction indicated by the dashed arrow “D2” in the figure. At the moment, the CIS 15a covers the whole of the moved bar code 10. In FIG. 3(b), furthermore, the bar code 10 performs a sub-scanning movement together with a shift in the main-scanning direction “D3” of the CIS. That is, the bar code 10 moves in a slanting direction, resulting in the displacement thereof from the position indicated by the line C-D to the position indicated by the line C′-D′.

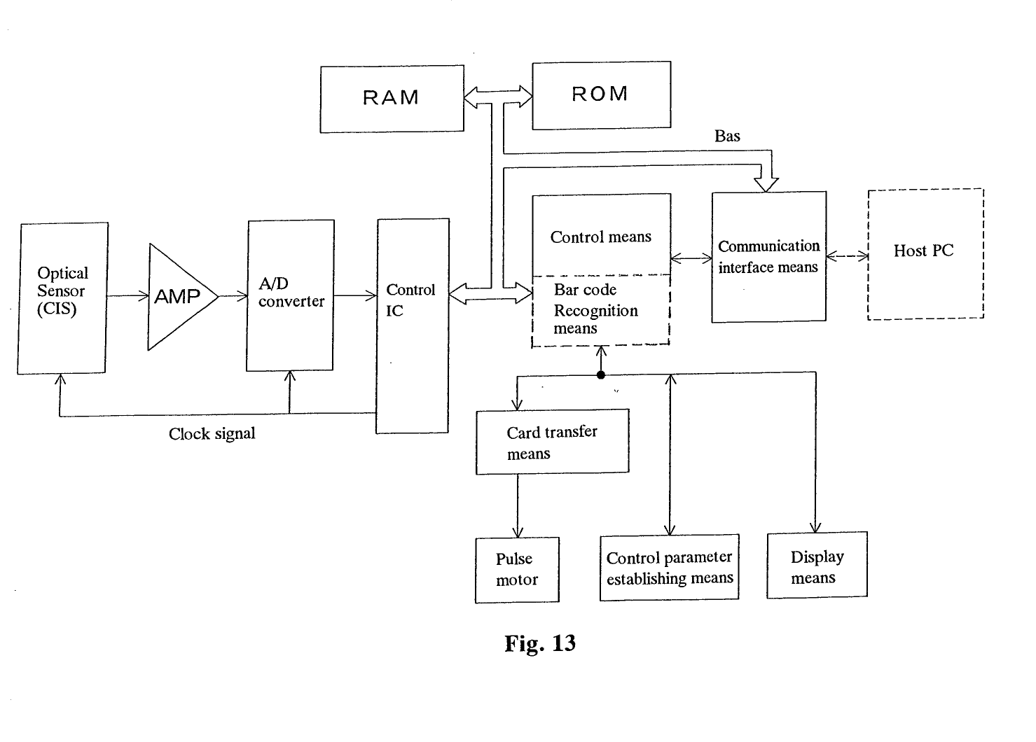

Accordingly, the relative displacement of the bars of the bar code ant the line sensor of the CIS is performed in a slanting direction, so that a high precision bar-code reading can be allowed even though there is the problems in the prior art shown in FIGS. 12(a) and 12(b), i.e., any defect such as fading, stain, or the like or any inferior pixel to be troubled.

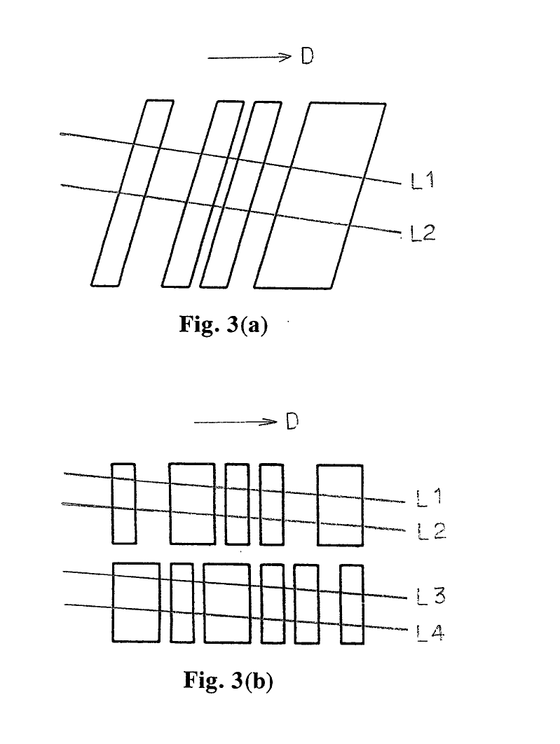

Referring now to FIGS. 2(a), 2(b), and 2(c), we will describe the operating principles of CIS of the present embodiment, which allows a high precision bar-code reading in spite of the presence of inferior pixel or defected bar, in detail.

FIGS. 2(a), 2(b), and 2(c) illustrate the first, second, and third reading positions, respectively. Each of these figures shows the positional relationship between the reading line and the bar code, where the bar code shifts its position slightly toward the lower right direction with respect to the reading line of the CIS.

The reading position of each bar is successively shifted in the lower right direction (i.e., along the line E-F) in FIGS. 2(a) to 2(c). In FIG. 2(a), the CIS 16a extends from E to F so that the main-scanning direction of CIS 16a and the sub-scanning direction of the bar code 11 cross each other at an angle of α. Here, if the pixel having any trouble is located at the position indicated by “X” in the figure, where the bar 11a and the CIS 16a cross each other, the reading at the first reading position becomes incorrect. If the bar code slightly shifts its position in the lower right direction, as shown in FIG. 2(b), the pixel at the above “X” position on the CIS 16a moves away from the bar 11a. Thus, the bar 11a can be read, correctly.

Furthermore, in spite that there is any defect such as faded or smudged portion on the bar 11a corresponding to the position “X” where the CIS 16a and the bar code 11 cross each other in FIG. 2(a), the CIS 16a moves away from the portion of the bar code 11a corresponding to the position “X” as the bar code 11 shifts its position. Thus, the bar 11a can be read, correctly.

According to the present invention, the shape of bar code to be read by the bar-code reader is not limited to those of shown in FIGS. 1(a) and 1(b) and FIGS. 2(a) to 2(c), which are typical shapes well known in the art. Another type of bar code, such as shown in FIG. 3(a) or 3(b), which is not usual in the art, may be applied on the present invention.

FIG. 3(a) illustrates a bar code consisting of slanted bars. In this figure, lead lines L1, L2 of the image sensor read the bar code in a slanting direction at a predetermined angle with respect to a direction “D” of relative displacement against the reading medium.

In addition, FIG. 3(b) illustrates the example of reading the slanting bar code just as in the case of FIG. 3(a), except that there are two parallel bar codes and two sets of reading lines. In this case, the upper bar code is read under the condition in which the upper reading lines L1, L2 read the upper bar code in a slanting direction at a predetermined angle with respect to a direction “D” of relative displacement against the reading medium. Similarly, the lower bar code is read under the condition in which the lower reading lines L3, L4 read the upper bar code in a slanting direction at a predetermined angle with respect to a direction “D” of relative displacement against the reading medium.

In FIG. 3(b), as described above, the upper and lower bar codes are read by the upper and lower sets of reading lines L1 and L2, L3 and L4, respectively. In this case, the vertical length of the image sensor may be at least twice as long as the width of the bar code (i.e., a length of each bar) so that the image sensor covers the whole of the upper and lower bar codes at once. Alternatively, it may be arranged so that the upper and lower bar codes are read independently.

Consequently, the bar-code reader of the present invention allows the reading of bar code in any shape. In other words, for example, it may be applied on not only the normal shape shown in FIGS. 1(a) and 1(b) but also the specific shape as shown in FIGS. 3(a) and 3(b).

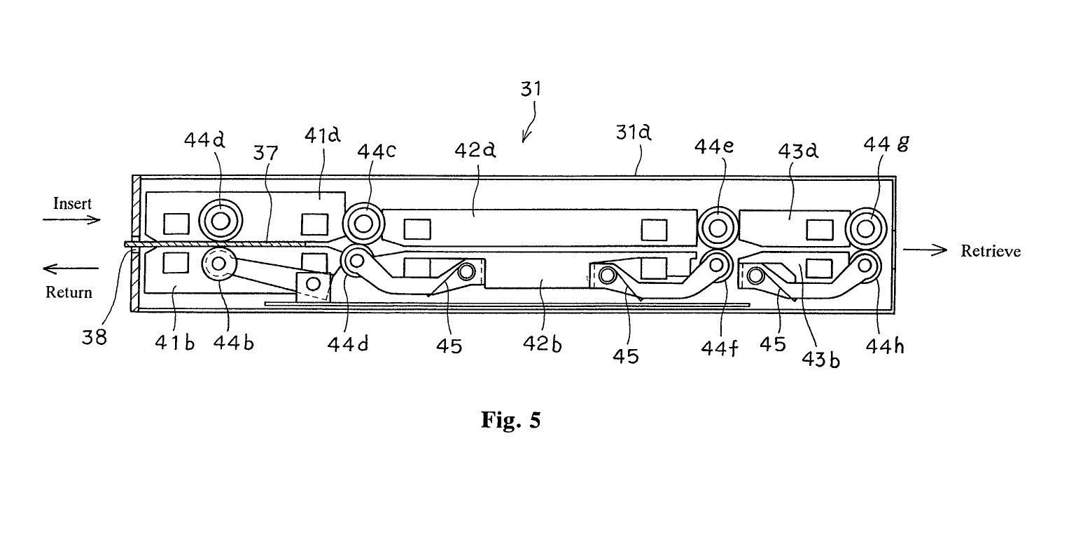

Referring now to FIGS. 4 to 7, we will describe preferred embodiment of the bar-code reader for performing the method of reading a bar code in accordance with the present invention.

FIG. 4 is a perspective diagram that illustrates a bar-code reader 31 as one of preferred embodiments of the present invention. The bar-code reader 31 is connected to a personal computer (not shown) and reads the information represented by a bar code 35 printed on an IC card 37. That is, the bar-code reader 31 comprises: a connector receptacle 32 for connecting with the computer through a connector 33; an insertion/removal slot 38 for inserting the IC card 37 into the body and ejecting the IC card 37 from the body after the completion of reading the bar code 35 on the IC card 37; and an image sensor (CIS) (not shown) for reading the bar code 35, which is arranged in a slanting direction at a predetermined angle with respect to the sub-scanning direction that corresponds to a direction of feeding the IC card 37 as described later. The information read by the CIS maybe temporally stored in a memory device (not shown) in the bar-code reader 31, or directly transmitted as detection data to a data processing device through an interface. In this embodiment, the bar-code reader 31 can be actuated by turning a start switch on. In addition, an upper lid 39 of the bar-code reader 31 can be opened around joint portions 40a, 40b in the direction of the arrow “P”.

At the time of performing a relative movement with the medium every one line to read the bar code, an array of photo-converting element may be inclined typically at a range of 2° to 8°, in consideration of the ratio of the height and the width of various types of bar codes which have been used or will be used in a this kind of business field. It goes without saying that the range of 2° to 8° can be changed otherwise in accordance with the ration of the height and the width of any type of bar cords.

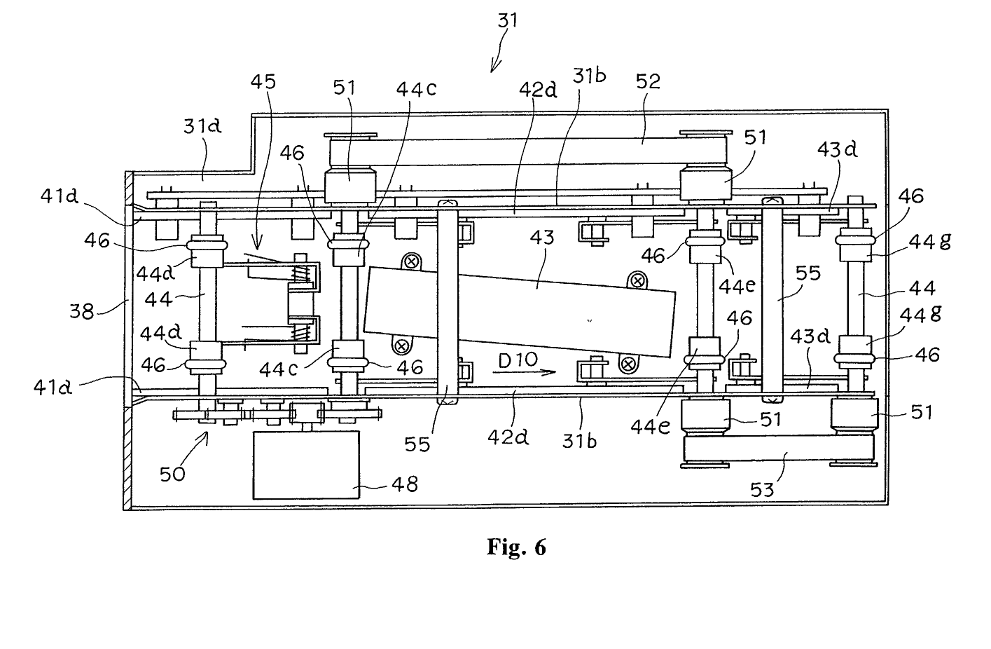

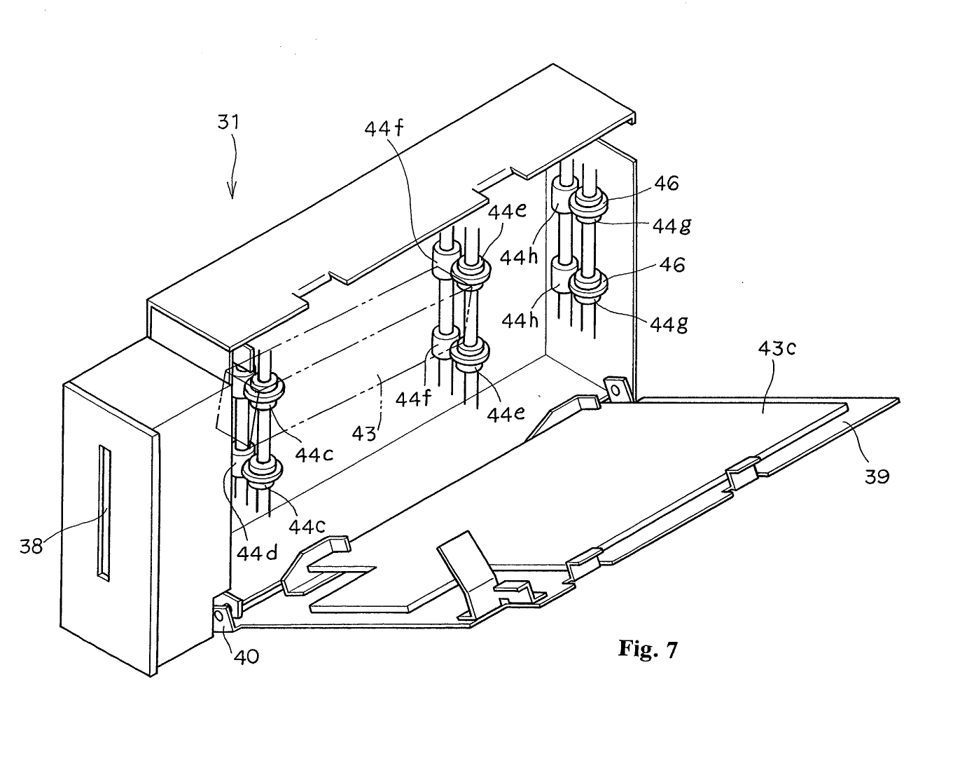

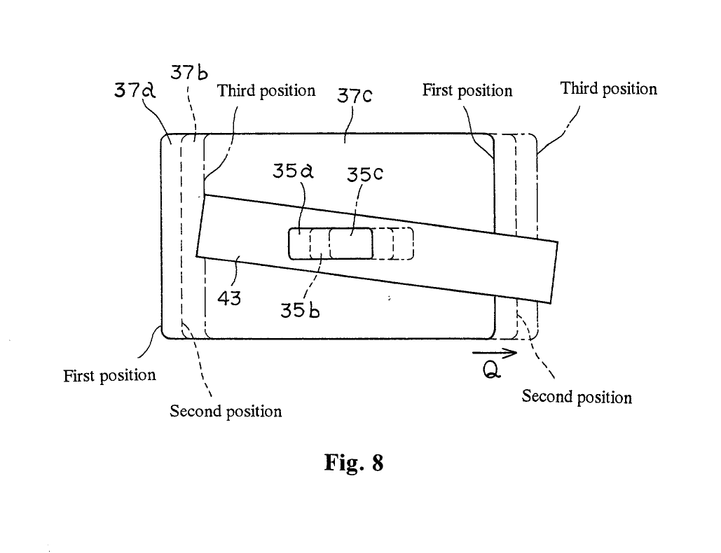

FIG. 5 and FIG. 6 illustrate the inner structure of the bar-code reader 31 viewed from the side and top, respectively. In addition, FIG. 7 is a perspective diagram that illustrates the bar-code reader 31 where the upper lid 39 is being opened.

As shown in FIGS. 5 and 6, the bar-code reader 31 comprises a body flame 31a and an inner flame 31b. In the inside of the inner flame 31b, furthermore, there are a first pair of card guide members 41a and 41b, a second pair of card guide members 42a and 42b, and a third pair of card guide members 43a and 43b for holding and feeding the IC card 37 inserted from the slot 3. Each of the pairs is provided as a pair of upper and lower guide members arranged in parallel with each other and their side surfaces face to the side walls of the bar-code reader 31, respectively. Furthermore, each pair of the guide member comprises a pair of guide rollers 44a and 44b, 44c and 44d, or 44e and 44f for receiving and feeding the IC card 37. In other words, there are four sets of upper and lower rollers, which are rotatably arranged on the different positions. In addition, each of the lower rollers 44b, 44d, 44f, and 44h is attached to a spring 45 that pushes the roller upward so as to move the IC card 37 in a stable manner. The CIS 43 for reading the bar code 35 printed on the IC card 37 (FIG. 4) is mounted on the upper side of the bar-code reader 31 so as to be arranged between the left and right sides of card guide member 42a and also between the rollers 44c and 44e. As shown in FIG. 6, furthermore, the CIS 43 is inclined at a predetermined angle (e.g., two to ten degrees, typically about five degrees) with resect to the direction D10 of moving the IC card 37 (i.e., the sub-scanning direction). The CIS 43 is connected to a CIS circuit 43c shown in FIG. 7 to perform the reading of bar code.

In FIG. 7, just as in the case of FIG. 5, we can recognize that the CIS 43 is inclined with respect to the direction of moving the IC card 37. Typically, but not limited to, the CIS 43 leans 5° with respect to the direction D1O of moving the IC card 37. Alternatively, such an angle may be adjusted on the basis of the length of CIS, the length of bar code to be read, the number of reading the bar code, and so on.

The IC card 37 disposed between the card guides 41a (or between the card guides 41a or 41b) is moved toward the bar-code reading portion described later by the driving force of a step motor 48 installed on the outside of the inner flame 31b through the rollers 44a, 44b and the rollers 44c, 44d. A shaft 44 of the roller c is driven together with that of the roller 44e by means of a first belt 52 through a pair of pulleys 51, so that the IC card 37 can be transferred at a constant speed. Similarly, a shaft 44 of the roller 44e is driven together with that of the roller 44d by means of a second belt 53 through a pair of pulleys 51, so that IC card 37 can be transferred at a constant speed. By the way, each of the upper rollers 44a and so on has an O ring on its peripheral surface to prevent the surface of IC card 37 from a scratch or the like.

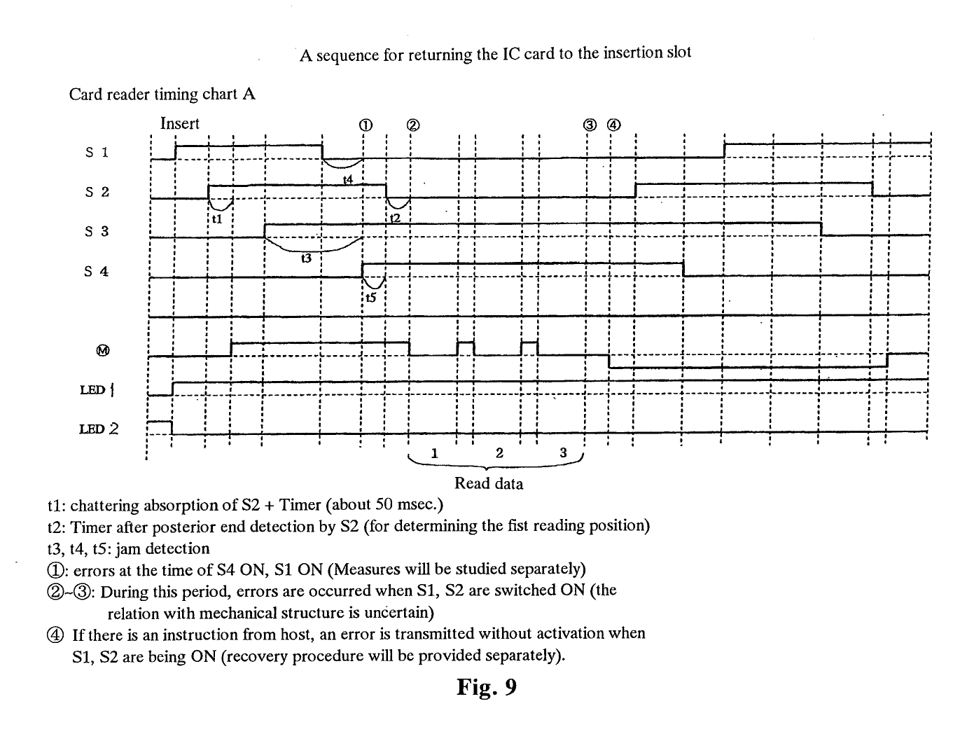

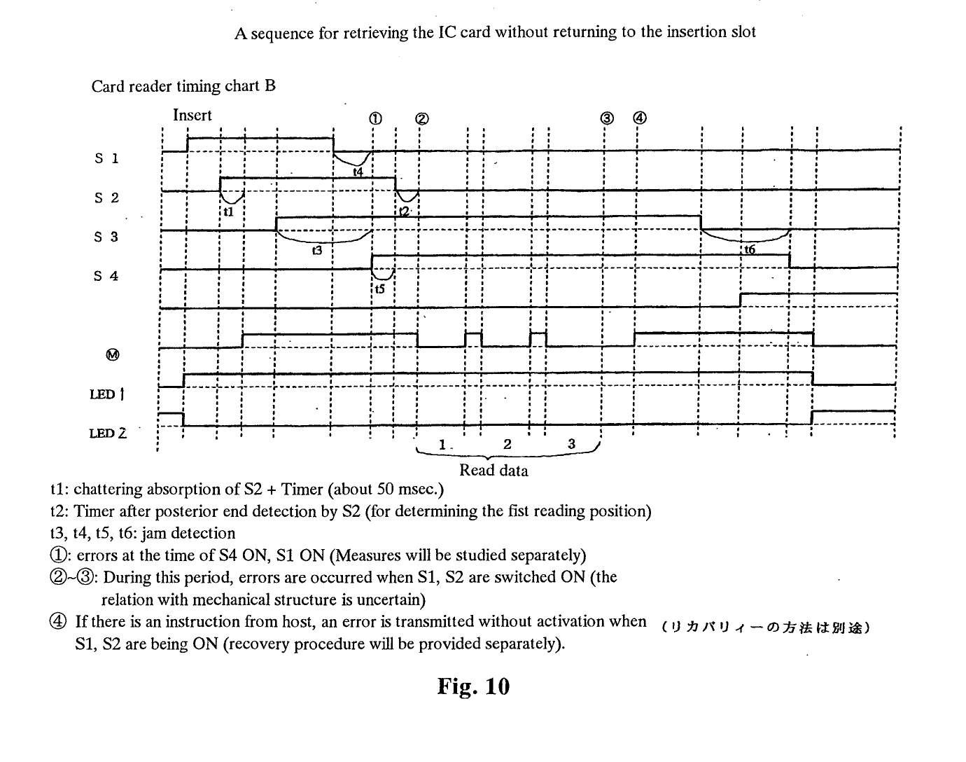

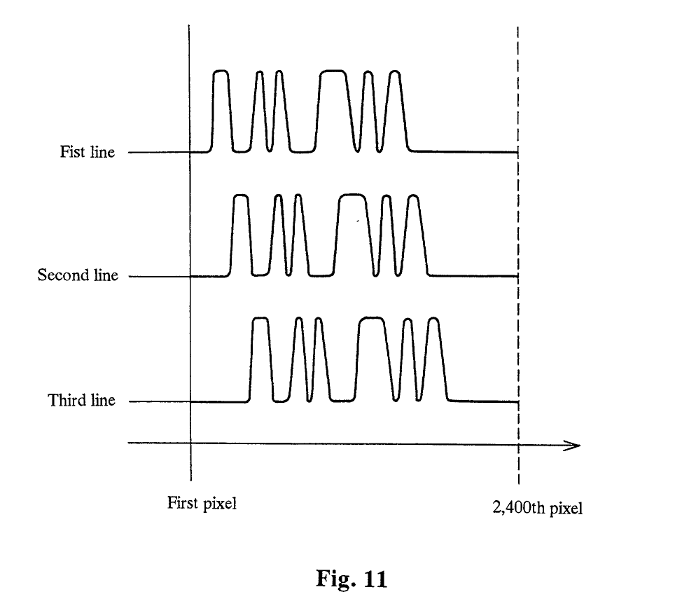

Now, the reading operation of the bar-code reader will be described in detail with reference to FIG. 8 to FIG. 10 in addition to FIG. 5 to FIG. 7. FIG. 8 is a schematic diagram that illustrates the positional relationship between the CIS 43 and the IC card 37, where the CIS 43 reads the bar code three times (i.e., the CIS 43 is allowed to read the bar code when the IC card 37 locates at one of three different positions). FIG. 9 and FIG. 10 is a schematic diagram that illustrates a timing and a relationship between the CIS 43 and the card 37 (i.e., bar code 35), where the CIS 43 reads the bar code three times. That is, FIG. 9 is a timing chart that indicates a sequence for returning the IC card 37 to the slot 38, while FIG. 10 is a timing chart that indicates a sequence for retrieving the IC card 37 without returning it to the slot 38.

First, a switch (not shown) of the bar-code reader 31 is turned on to electrically connect to the computer (not shown) in addition to actuate the step motor 48. Subsequently, the IC card 37 on which a bar code 35 to be read is inserted into the bar-code reader 31 through the slot 38. Then, the inserted card 37 is guided on every side by the card guide members 41a, 41b and fed to the CIS 43 by the rollers 44a, 44b followed by the rollers 44c, 44d. If the tip of the IC card 37 reaches a first reading position (a first position), then the step motor 40 is stopped to pause the installation of IC card 37. Under such a condition, one line of the CIS 43 reads the bar code on the IC card 37 to provide a first data. Next, the IC card 37 is further transferred to a second reading position (a second position) shown in FIG. 7 by actuating the step motor 48 again, followed by similarly reading the bar code with one line of the CIS to provide a second data. Furthermore, the IC card 37 is further transferred to a third reading position (a third position) by the step motor 48, followed by similarly reading the bar code with one line of the CIS to provide a third data. The reading data thus obtained is encoded and compared with each other. If at least two data is matched with each other, then the data is true one. Thus, it is determined that the reading is performed correctly. Consequently, each IC card 37, which is defined as one read correctly, is returned to the slot 38 by each of the rollers being rotated by a reverse rotary motion of the step motor 48. At last, the IC card 37 is pulled out of the bar-code reader 31 and subsequently the switch SI is turned off. As a result, a green light-emitting diode (LED ) 1 is switched on and a red LED 2 is switched off.

In the above steps, on the other hand, if there is no matched pair among three data, i.e., the first, second, and third data, the reading is determined as an error and the IC card 37 is ejected from a discharge port one the opposite side of the bar-code reader 31 with respect to the insertion/removal slot 38. In this embodiment, but not limited to, the process is configured so that the bar code is read three times. If the bar code to be read is still in the effective reading range of the CIS 43 (put another way, if the whole of bar code is still covered by one line of the CIS 43), then the bar code can be read four or more times.

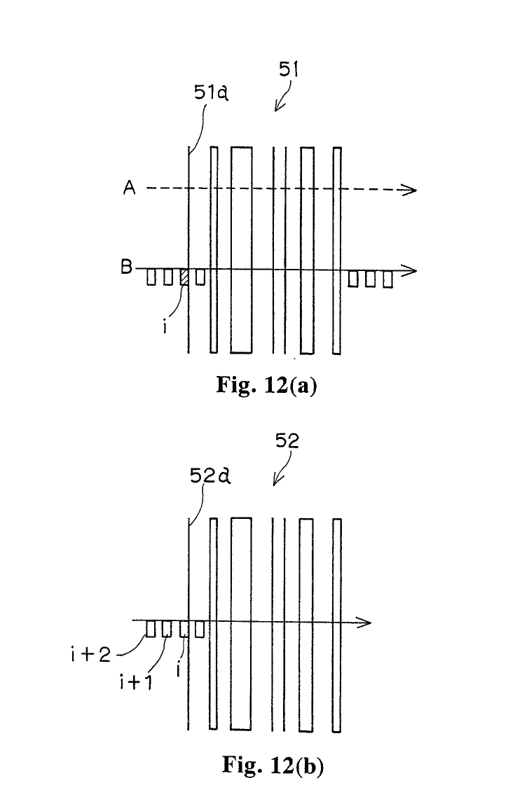

FIG. 11 is a timing chart that illustrates a positional relationship between the bar-code data printed on the card and the read line (a row of pixels) of the CIS. In this embodiment, as described above, the phrase of “the bar code is read three times” means that the bar code is read by three different rows of pixels (i.e., three different read lines: a first line, a second line, and a third line). In this embodiment, the bar code can be located in the area defined by the row of pixels (1 to 24000 pixels), so that the bar code can be read four or more times unless the bar code is out of the range of pixels.

In another bar-code reader as another embodiment of the present invention, a bar-code recognition means is further comprised. In this embodiment, that is, the bar code can be recognized on the basis of the bar-code data obtained by reading the bar code several times, and then the recognized bar code is converted into a numerical form, resulting in code data that takes numerical form to be generated from the bar-code reader to the outside. To be more specific, the bar code is read several times by a scanning movement of the optical sensor and then the bar-code recognition means recognizes the bar code every time it is read. Subsequently, the recognition results are subjected to the judgement whether they correspond with each other. If one of the recognition results corresponds with others, the corresponding result is generated as a code data from the bar-code reader to the outside. if they are not matched with each other, then the card transport means returns the card to the insertion/removal slot 38.

As shown in FIG. 11, in this embodiment, the read lines of the image sensor and the code line of the bar code are arranged to be crossed at a predetermined angle. Under such a configuration, the image sensor reads the bar code several times with the relative movement between the card and the image sensor in parallel with each other. Therefore, the detecting image data is shifted along the main-scanning direction of the image sensor. Therefore, there is a need to cut out of the detecting image data. The cut-out of image data being detected may be performed on the digital data obtained by the digital conversion of analog signals from the image sensor. Alternatively, it may be performed after the code conversion after the digital conversion. From the foregoing, the cut-out of image data and the code conversion may be performed on an external device or the like, or alternatively performed on an internal device or the like having such functions equipped in the bar-code reader.

Furthermore, if one of the recognizing results does not coincident with the predetermined numbers or percentage of others after reading and recognizing the bar cord several times by the optical sensor, then the card transport returns the card to the insertion/removal slot of the bar-code reader and then moves the card forward in the main-scanning direction once more to read the bar code on the card. Typically, the recognition of bar code is performed by an external device.

Accordingly, the bar-code reader of the present embodiment comprises a transport means and a selection means for returning the card once read to the card insertion/removal slot 36 or ejecting it from the card-ejection slot in response to the results of making a judgement on the recognition of bar code by the external device.

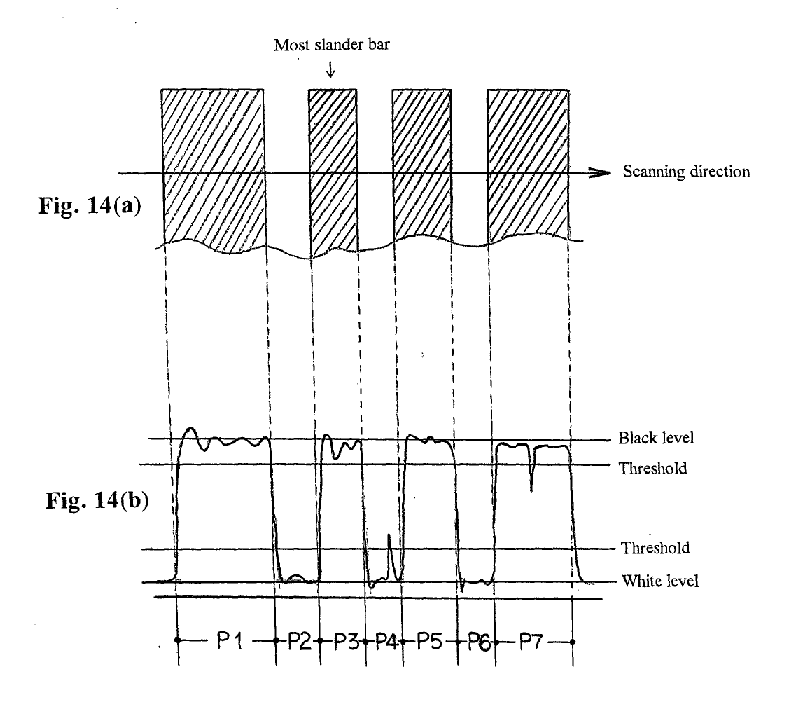

FIG. 13 is a block diagram that illustrates a control means of an image reader in accordance with another preferred embodiment of the present invention, in which the image reader comprises the bar-code recognition means described above. As described above, an image printed on a sheet of manuscript is subsequently read by an optical-detecting means. In this embodiment, the optical-detecting means may be a close type optical line sensor (CIS) described above, or alternatively may be an optical reduction type one such as CCD image sensor. The bar-code information read by the CIS is provided as a serial data of a row of pits and entered in an amplifier (AMP) every time a clock signal is supplied from the control integrated circuit (control IC) and amplified to perform a signal-level correction. The level-corrected analog data is converted into digital data depending on its gradation. In the bar-code reader in accordance with the first preferred embodiment of the present invention, the digital-converted data is typically transmitted to the external device, just as it is. Then, the external device performs the process of code recognition on the digital signals and determines that the results of recognition are correct or not, followed by sending the results to the bar-code reader. Depending on the results from the external device, the card once read is sent to the card ejection slot or returned to the card insertion/removal slot 38.

A bar-code reader in accordance with a second preferred embodiment of the present invention, as indicated by a dotted line in FIG. 13, a bar-code recognition means is installed in the bar-code reader so that the reading bar code can be subjected to the process of code recognition by such a means. In this case, the reading bar code information is tied up in a bundle of data with the predetermined number of bytes and temporally placed in a storage means such as a random access memory (RAM) at the given address, followed by subjecting the stored data by a bar-code recognition means in the control unit. The data obtained by reading the bar code several times may be subjected to the code recognition every time the reader reads the bar code. Alternatively, the data is successively stored in the memory and then subjected to the code recognition. In FIG. 13, ROM stores an operation program of the bar-code reader, a program of the above code recognition, and a control fixed data. On the other hand, a control parameter configuration means is used to determine the number of read operations, establish the mode of performing the above code recognition when there is no coincidence of the read data, and so on.

Here, the process of reading a bar code by the bar-code reader in accordance with the present invention will described below.

A change in the shape of bar code with a deposition of dust or the like or fading also causes an error in the bar-code reading.

In this invention, for solving such a disadvantage, the bar-code reader is designed to keep an excellent bar-code reading by eliminating any trouble in the shape of bar code. That is, if the surface of bar code to be read is stained, faded, or the like and any noise is caused in the read image data obtained from such a bar code, the bar-code reader eliminates such a nose to perform the bar-code reading normally.

The bar-code reader of the present embodiment comprises an image sensor for optically reading an image consisting of binary pixels, an analog-to-digital converter (ADC) by which analog signals obtained from the image sensor can be converted into digital form, and memory that temporally stores the digital signals from the ADC as image data.

By the way, the present invention provides the process of reading the bar code that comprises the following steps. That is, a threshold is calculated on the basis of the respective concentration levels of pixels of the whole or the predetermined range of image data being stored in the memory. Then, each pixel is expressed as a value of “black” or “white” with reference to the predetermined threshold. If one of binary pixels is changed from “black” or “white” to the other, it is considered as a normal data when it represents the same value for the predetermined number of bar-code reading. On the other hand, it is considered as a noise when it cannot represent the same value for that period. Thus, it is considered that the process keeps the original value. Subsequently, the resulting binary image data is recognized on the basis of a predetermined algorithm, and then the results of recognition are transmitted to an external device.

The principle underlying such noise detection in the present invention will be explained as follows.

In the case of performing the bar-code reading, the bar-code reader reads a pixel made of several dots even though a target bar element in the bar code has the minimum width compared with those of other elements. For example, in the configuration of bar code defined in Code 39 of the international standard for bar codes, the most slender bar element (either “black” or “white” ) is of 0.26 mm in thickness. If such a bar element is read by an image sensor having a read density of 600 dpi, then the number of read pixels in the most slender bar element is 6.14 dots.

In the read data of bar code, the same “black” or “white” read levels are continuously expressed on at least six dots. If there is a change in level within six pixel dotes, therefore, it means that a noise is detected.

According to the present, therefore, if the read image data of less than the predetermined number of continuously-leveled pixels is generated, it is processed as a noise to improve the read accuracy in view of the minimum number of pixel in the case of reading the most slender bar element which is one of those in the bar code of the predetermined standard and the read pixel density of the image sensor.

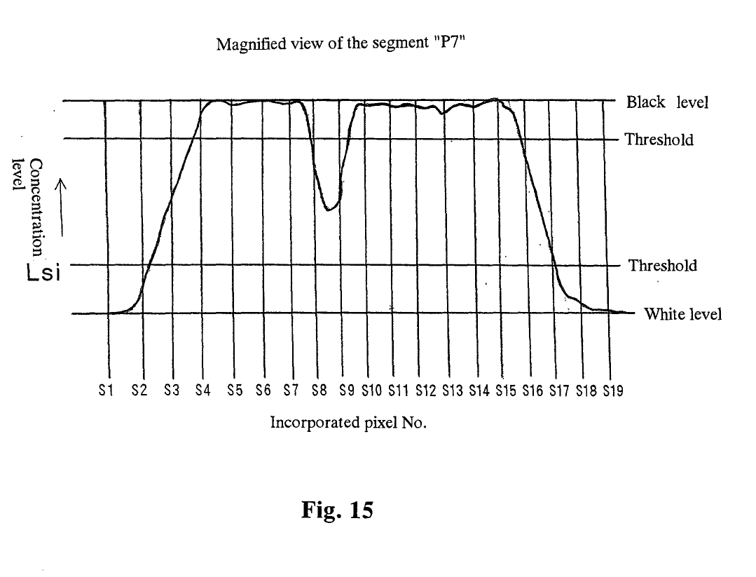

FIG. 14(a) is a schematic diagram that illustrates the configuration of bar code and the direction along which the bar-code reader performs a scanning movement. FIG. 14(b) is a graph of analog image data obtained by reading the bar code shown in FIG. 14(a), where black and white levels of each bar element and the thresholds thereof are represented.

As described above, each bar element of the bar code, even the most slender bar element thereof, can be read as a contiguous sequence of several dots having the same level (“1” or “0”). Each white space between the bar codes is also read by the same way as that of the black bar code. As shown in FIG. 14(a), the bar code is represented by black and white bar elements of different widths. If the image sensor is moved across the code or the code itself is moved across the image sensor to read the bar elements of the bar code in the scanning direction, each of the bar elements is read as analog image data as shown in FIG. 14(b). In the figure, the sections from “P1” to “P7” corresponds to the reading bar elements and their respective analog image data obtained by the reading operation. If the black bar element is read, in general, a contiguous sequence of high level (black level) data is observed. If the white bar element is read, on the other hand, a contiguous sequence of low level (whit level) data is observed. If the level of the bar element is changed by the noise generation in the reader, or by the adhesion of dust, staining, or the like, the image data read by the image sensor can be also changed. In FIG. 14(b), for example, there is shown a short waveform where the concentration level thereof is higher than the threshold in the sections between “P4” and “P7”.

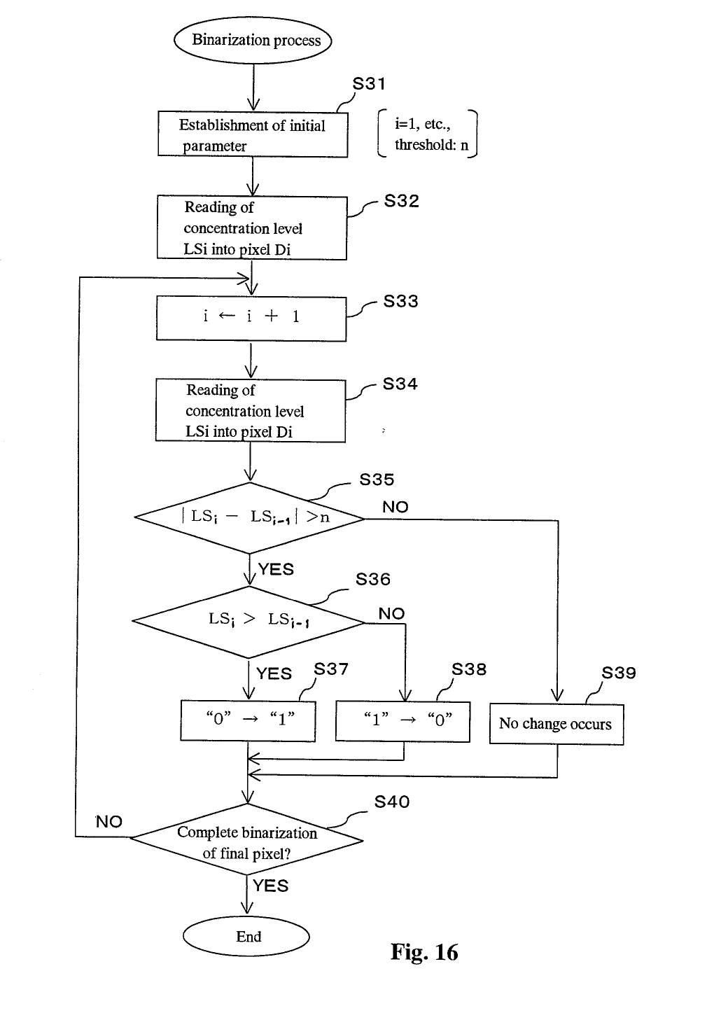

FIG. 15 is a magnified view of the section “P7” of the bar element shown in FIG. 14(b). In this figure, concentration levels are plotted on the vertical axis, while pixel numbers are plotted on the horizontal axis. In this figure, the concentration level is lower than the threshold at the pixel numbers “S8” and “S9” of the section “P7”.

In the section “S7”, the concentration level is lower than the threshold of white level, so that the bar element corresponding to such a section is still represented as white (“0”). In the area defined by the pixel numbers from “S2” to “S3”, the concentration level exceeds the threshold of white level but less than the black level. Thus, it is considered that the pixel numbers from “S2” and “S3” correspond to a transient area of changing from the white to the black. The pixel number “S4” is a black level and the pixel numbers from “S4” to “S5” have the same level, so that a concentration check is started. From the pixel numbers “S5” to “S7”, the concentration level is constant and higher than the threshold of black, so that the portion of the bar element corresponding to these pixel numbers is considered as black. Furthermore, the pixel numbers from “S9” and “S10” correspond to a transient area of changing from the black to the white. Finally, at the pixel number “S10”, the concentration level of bar element returns to the black level. In this analysis, therefore, it is determined that the changes in concentration level at the pixel numbers from “S8” to “S10” can be noise because the total number of pixels is less than the predetermined one. The pixel number “S10” is a black level and the pixel numbers from “S10” to “S15” have the same level, so that a concentration check is started. From the pixel numbers “S10” to “S15”, the concentration level is constant and higher than the threshold of black, so that the portion of the bar element corresponding to these pixel numbers is considered as black. Furthermore, the pixel numbers from “S15” and “S17” lower than the threshold of black level but higher than that of white level, so that these pixel numbers correspond to a transient area of changing from the black to the white. At the pixel number “S18”, the concentration level is lower than the threshold of black level and reaches to that of white level, so that it is considered that it is changed to the white. Similarly, the pixel number “Sl9” is also defined as the white, resulting in the start of concentration level check. In this embodiment, therefore, the process determines that the section “P7” corresponds to the black with noise.

In summary, as described above, the first example of the binarization with reference to the threshold standard in accordance with the present invention is based on whether the concentration level of each pixel of the detecting image data is changed so that it becomes higher than the predetermined range of concentration levels (threshold). Then, the concentration level of the adjacent pixel is defined with respect to the concentration level of a contiguous sequence of several pixels which are adjacent to each other and defined as “1” or “O”.

The second example of the binarization with reference to the threshold standard is performed on the basis of the threshold standard previously defined as “1” or “O”. As a characteristic feature of the present invention is to define the predetermined number of pixels for the above determination means is based on the number of pixels read from the most slender bar element among all bar elements in the bar code.

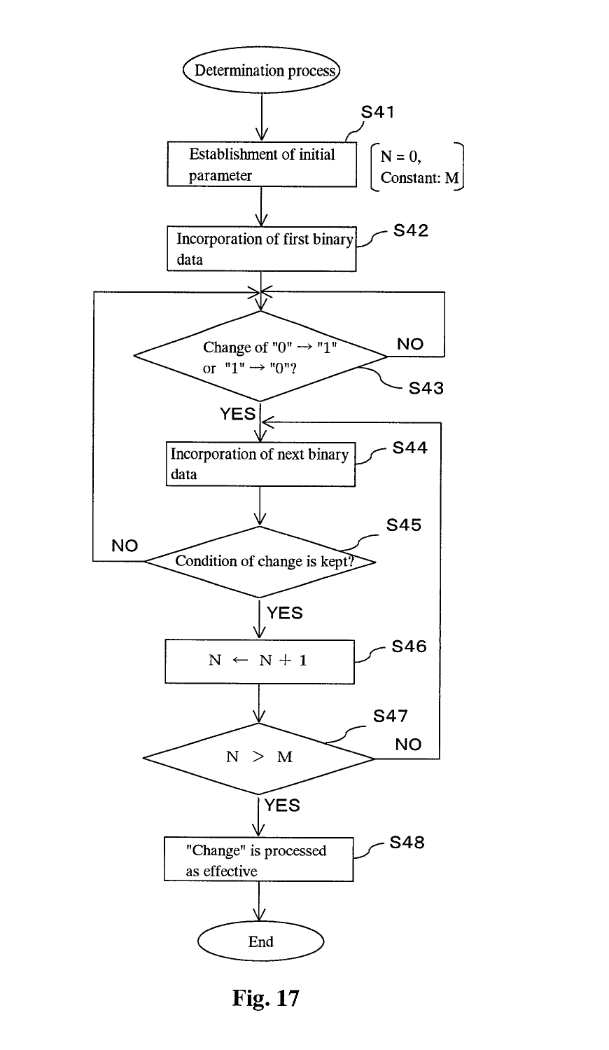

FIG. 16 is a flow chart that illustrates each step of representing the reading image in binary form. Referring this figure, we will explain the process of converting the image data in a binary form of “1”(black) or “0”(white) on the basis of the number of the predetermined contiguous pixels and the threshold standard.

As shown in FIG. 16, at first, an initial parameter is specified (S31), for example, which is line (i), threshold (n), or the like. Then, the reading of a first line of the bar element is started (S32). Subsequently, for reading the line next to the present line position “i”, the line position “i+1” is processed to specify the line to be read (S33). A line of the bar element on the specified position is read (S34). The difference of concentration levels between the line presently read and the line previously read is compared with the threshold “n” (S35). If it is judged that such a compared difference is changed so that it becomes larger than the threshold, it is determined which is higher the level previously read and the level presently read (S36). If the level previously read is less than the level presently read, it is judged that the level is changed from “0” to“1” (S37). Furthermore, if the level previously read is higher than the level presently read, it is judged that the level is changed from “1” to(S38). Next, a judgement is made to determine whether it is a final pixel line to be converted into binary form (S40). If it is not final, then the process returns to the step of renewing the number of pixels to be read and the process proceeds from the step of reading the next pixel line just as in the case of described above. If it is a final pixel, then the binarization is completed. In addition, a comparison between the line previously read and the line presently read is made with respect to the concentration level (S35), and then a judgement is made to determine it is a final pixel line in binary form (S40). If it is not final, then the process returns to the step of reading the next pixel and then the above steps are repeated until it reaches to the final pixel.

FIG. 17 is a flow chart that illustrates the process of binary data determination represented in FIG. 16.

In the step of performing the determination procedure, at first an initial parameter is established (S41). Here, the predetermined number (N) of pixels, which specifies the number of pixels having the same level on a continual basis to be provided as a judgement standard for noise or the like. Then, a first binary data is incorporated (S42). A judgement is made to determine whether the change from “O” to “1 ” or from “1” to “O” is occurred in the next step (S43). If it is judged that the change has occurred, next binary data is incorporated (S44). A comparison between the data presently incorporated and the data previously incorporated is performed (S45). If it is judged that there is no change in the incorporated data, then the process returns to the step to incorporate next data. Alternatively, if it is judged that the change has occurred in the data being incorporated, the number N of binary data being incorporated is incremented by “1” and then it is stored as a new number of binary data being incorporated (S46). The new number of the incorporation is compared with the constant “M” which is previously defined (S47). If the number N of the data being incorporated is larger than the predetermined number M, then the above change is regarded as an effective one so that it is provided as data that specifies “O” or “1” (S48). In addition, if the number N of the data being incorporated is smaller than the constant M, then it is judged to noise or the like and then the process returns to the step of incorporating binary data (S44), the process maintains the step of incorporating the next binary data just as in the case of described above.

By the way, the reading target of the bar-code reader of the present invention allows the perfect and high-precision optical reading even though any trouble in a part of optical elements, or any defect such as fading or dirt in the bar code, it is possible to read such a bar code with perfection and the high precision.

Furthermore, in accordance with the present invention, if each binary pixel is changed from one value (for example “1”) to the other (for example “O”) and it returns to an original value after the predetermined number of sequential pixels shows the same value, the binary pixel is used as normal data as it is. On the other hand, it returns to an original value before the predetermined number of sequential pixels shows the same value, it is regarded as noise and the process proceeds as if the original value is maintained. For reading the bar code printed on the card, consequently, the bar-code reader of the present invention allows the perfect and high-precision optical reading even though any trouble in a part of optical elements, or any defect such as fading or dirt in the bar code, it is possible to read such a bar code with perfection and the high precision. In the present invention, furthermore, as disclosed in the prior art, if any noise is on the image data to be detected, the noise is not reflected on the threshold which is variably established. Thus, the precision of incorporating bar code can be preferably realized.

The present invention has been described in detail with respect to preferred embodiments, and it will be obvious to those skilled in the art that changes and modifications may be made without departing from the invention in its broader aspects, and it is the intention, therefore, in the appended claims to cover all such changes and modifications as fall within in the true spirit of the invention.

What is claimed is:

1. A bar-code reading system that includes a reading means for reading a medium on which a bar code is printed, by an image sensor having photo-electric conversion elements arranged in line, and a processing means for performing a predetermined process on the basis of information read by the reading means, comprising:
a driving means for performing a relative movement between the photo-electric conversion elements and the medium, which crosses at a predetermined angle, wherein
the processing means comprises:
a reading instruction means for instructing the reading means with a reading of one line by photo-electric conversion elements concurrently with the relative movement by the driving means;
a judgement means for making a judgement on the basis of reading information of at least two lines, and
a control means for control the reading instruction means on the basis of an judgement information by the judgement means.

2. A bar-code reading system that includes a reading means for reading a medium on which a bar code is printed, by an image sensor having photo-electric conversion elements arranged in line, and a driving means for moving the image sensor, wherein
the image sensor is moved as the driving means and the an array of the photoelectric conversion elements cross each other at a predetermined angle.

3. A bar-code reading system that includes a reading means for reading a medium on which a bar code is printed, by an image sensor having photo-electric conversion elements arranged in line, and a transport means to transport a medium, wherein
the transport means and an array of photo-electric conversion elements cross each other at a predetermined angle.

4. A bar-code reader that includes a reading means for reading a medium on which a bar code is printed, by an image sensor having photo-electric conversion elements arranged in line, and a transport means to transport a medium, wherein
the direction of setting the medium at an insertion/removal slot and an array of image cross with each other.

5. A bar-code reader that includes a reading means for reading a bar-code on a medium by an image sensor having an optical source and an array of photo-electric conversion elements in line, where the array of photo-electric conversion elements is inclined at a predetermined angle and performs a relative movement with the medium to read the bar-code every one line, comprising:
a reading instruction means for instructing the reading means to read one line;
a judgment means for making the judgment on the basis of the reading information of at least two lines, and
a control means for controlling the reading instruction means on the basis of the judgment information.

6. A bar-code reader as claimed in claim 1, wherein
the judgment means comprises a comparison means for making a comparison between the reading information obtained by the reading means and the retry means for instructing the reading instruction means to read again when the comparison results are not agreed.

7. A bar-code reader as claimed in claim 6, wherein
the judgment means further comprises an error processing means for performing an error processing when the number of the re-readings reaches the predetermined number and it is considered as an error.

8. A bar-code reader as claimed in claim 7 as claimed in claim 5, wherein the judgment means further comprises a noise examination means that examines whether the noise is in the reading information read by the reading means.

9. A bar-code reader as claimed in claim 8, wherein
the noise examination means sequentially examines the reading information from an image sensor by counting the number of pixels from the predetermined pixel position, and
if the number of pixels is specifically changed before a predetermined number of movements is completed, it is considered as noise.

10. A bar-code reader as claimed in claim 5, wherein
at the time of performing a relative movement with the medium every one line to read the bar code, an array of photo-converting element is inclined at a range of 2° to 8°.

11. A bar-code reader that includes a reading means that includes a reading means for reading a medium on which a bar code is printed, by an image sensor having photo-electric conversion elements arranged in line, and a driving means for performing a relative movement between a reading line of the reading means and the medium, comprising:
an interface means that connects to an external device and performs a signal transmission/reception with an external device;
a reading instruction means that instructs the reading means to perform one line reading by the photo-electric conversion elements under a relative movement by the driving means in response to a control signal from the external device through the interface means; and
a transmission means for transmitting reading information read from the reading means to the external device through the interface means.

12. A bar-code reader as claimed in claim 11, further comprising:
a comparison means for making a comparison between the reading information obtained from the respective lines by the reading means; and
the retry means for instructing the reading instruction means to read again when the comparison results are not agreed.

13. A bar-code reader as claimed in claim 11, further comprises an error processing means for performing an error processing when the number of the rereadings reaches the predetermined number and it is considered as an error.

14. A bar-code reader as claimed in claim 11, where the reading instruction means is actuated in response to a control signal received from the interface means.

15. A bar-code reader as claimed in claim 11, further comprises a conversion means for converting reading information into code information, where the bar-code information is sent from the interface to an external device.

16. A bar-code reader as claimed in claim 11, wherein at the time of performing a relative movement with the medium every one line to read the bar code, an array of photo-converting element is inclined at a range of 2° to 8°.

17. A bar-code reader that includes a reading means for reading a medium on which a bar code is printed, by an image sensor having photo-electric conversion elements arranged in line, and a driving means for performing a relative movement between a reading line of the reading means and the medium, where the reading means is arranged to read the bar code and a reading line which cross each other at a predetermined angle, comprising:
a medium-receiving slot for receiving the medium;
a medium-ejecting slot for ejecting the medium; and
an instruction means for instructing a transport means to transport the medium either the medium-receiving slot or the medium-ejecting slot.

18. A bar-code reader as claimed in claim 17, further comprising:
a comparison means for making a comparison between the reading information obtained by the reading means;
retry means for instructing the reading instruction means to read again when the comparison results are not agreed; and
an error processing means for moving the medium to the medium-receiving slot or the medium-ejecting slot when the number of the re-readings reaches the predetermined number and it is considered as an error.

19. A bar-code reader as claimed in claim 17, wherein
the driving means is controlled so that the medium is moved to the medium-receiving slot or the medium-ejecting slot in response to a control signal received from the interface means.

20. A bar-code reader as claimed in claim 17, wherein
the judgment means further comprises a noise examination means that examines whether the noise is in the reading information read by the reading means.

21. A bar-code reader as claimed in claim 20, wherein
the noise examination means sequentially examines output levels of image sensor from a predetermined pixel position, and if the change of more than the predetermined level is detected during the movement through the pixels of less than predetermined number, it is considered as noise.

22. A bar-code reader as claimed in claim 17, wherein the bar code on the medium and the reading line cross each other at a predetermined angle of 2° to 8°.

23. A bar-code recording medium on which a bar code is printed, wherein
the bar code is printed so that the bar code and one side edge of the medium crosses at a predetermined angle.

24. A bar-code recording medium as claimed in claim 23, wherein
the recording medium is shaped like a general rectangular card.

25. A bar-code representing medium claimed in claim 23, where
the bar code is printed so that the bar code and one side edge of the medium crosses at an angle of 2° to 8°.

26. A recording medium for a bar-code reader that transports the recording medium on which a bar code is printed and reads the bar code on the recording medium by an array of photo-electric conversion elements in line, wherein
the bar code is printed so that it consists of a group of straight-lines which are parallel with each other, and
the bar code and the direction of transporting the bar code crosses together at a predetermined angle.

27. A method of reading a bar code having the step of reading a bar code printed on a medium by an image sensor in which photo-electric conversion elements are arranged in line, wherein
in the step of reading the bar code, the bar code is read under the condition in which the reading line and the bar code cross together at a predetermined angle.

28. A method of reading a bar code as claimed in claim 27, wherein
the step of reading the bar code further comprises a step of performing a relative movement of the reading line and the bar code.

29. A method as claimed in claim 27, further comprises the steps of:
repeating the step of reading several times by moving the step of reading, performing a predetermined judgment on the basis of the reading information obtained by the step of reading being performed several times, and performing an error processing to determine the error processing on the basis of the results of the judgment step.
